(19) United States
(12) Patent Application Publication
(10) Pub. No.: US 2017/0350652 A1
(43) Pub. Date: Dec. 7, 2017

(54) DRYER FOR TECHNICAL ITEMS, PARTICULARLY FOR PAINTED MOTOR VEHICLE BODIES

(71) Applicant: WENKER GmbH & Co. KG, Ahaus (DE)

(72) Inventor: Franz LEERS, Ahaus (DE)

(21) Appl. No.: 15/521,203

(22) PCT Filed: Oct. 21, 2015
(86) PCT No.: PCT/DE2015/000520

§ 371 Date: Apr. 21, 2017

(30) Foreign Application Priority Data
Oct. 22, 2014 (DE) 10 2014 015 705.9

(51) Int. Cl. F26B 25/12; F26B 25/10

(52) U.S. Cl. CPC F26B 25/12; F26B 25/10; F26B 2210/12

(57) ABSTRACT

In a drier for industrial articles, in particular for painted motor vehicle bodies, comprising at least one booth for the industrial articles and for drying tools, the booth of the drier is formed by walls arranged at a distance from components near the outside of the booth and other than the support feet of the booth. This drier can keep the heat introduced into the booth longer, preventing radiation losses, in particular.

### BACKGROUND OF THE INVENTION

### Field of the Invention

The invention relates to a dryer for technical items, particularly for painted motor vehicle bodies, comprising at least one cabin for the technical items and for drying tools.

### Brief Description of the Related Art

Items that differ from one another are to be dried during their production or after their production. For example, painted technical items, such as painted motor vehicle bodies, are to be dried, in order to achieve an accelerated curing of the applied paint during the assembly of the technical items.

Appropriate dryers are known in the prior art. The dryers generally have a cabin, into which the technical items are introduced. Drying tools or installations that are present are essentially arranged inside the cabin, they guide heated air onto the technical items, for example.

Owing to the supply of the heated air, there is a high temperature in the interior of the dryer. In order to produce and maintain this high temperature, heat energy is to be supplied into the cabin continuously, also in order to compensate heat losses that arise, for example due to radiated heat. The generation of the corresponding energy is expensive owing to increasing energy prices.

### SUMMARY OF THE INVENTION

The object of the invention is to show a dryer of the generic type mentioned at the beginning, which can keep the introduced heat in the cabin for longer and in which radiation losses in particular are prevented.

This object is achieved according to the invention, in that the cabin of the dryer is constructed from walls, which in each case have a spacing from components which are brought closer to the cabin from outside and differ from the installation feet of the cabin.

In the case of the dryer according to the invention, the cabin usually has walls as in the prior art. Furthermore, the cabin has installation feet. According to the invention, only the installation feet get closer to components brought closer to the cabin from the outside. The cabin can be installed on a substrate using the installation feet. The walls of the cabin then have a spacing from components brought closer from the outside, so that there is no physical connection between this cabin and external components. As a result, it is ensured that there can be no heat bridges, via which heat can escape from the interior of the cabin to the outside.

The inner cabin according to invention is therefore an inherently closed and insulated housing, the walls depicting the housing are self-supporting. According to a first development of the invention, it is provided that sealing elements are provided at the abutting edges of mutually adjacent walls of the cabin. In this respect, it is ensured that heat also cannot escape from the interior of the cabin via the abutting edges of two walls. The sealing elements for example comprise folded metal sheets, which can protrude in certain sections in a gap between two mutually adjacent walls of the cabin.

Components can nonetheless be brought, from the outside, closer to the cabin thermally insulated in this manner. According to a next development, it is provided that components brought from the outside closer to the cabin are combined to form a supporting frame, which has frame sections surrounding the cabin. The thermally insulated cabin has its own walls securing its construction. A supporting frame is therefore not required for constructing the cabin, thus it is possible for this supporting frame to have no contact with the inner cabin, but nonetheless form an outer framework for it. The outer framework is constructed with frame sections, these frame sections can accommodate loads, for example lines for media or electricity to be laid above the cabin.

The supporting frame can be framed with flat elements at least in certain sections, in order to here construct a closed exterior and to completely enclose the cabin in this manner.

A next development of the invention provides that installation feet are arranged on the outer side of the wall which is used as the floor of the cabin. The cabin can be installed on a substrate by means of these installation feet, wherein this substrate can be constructed according to a next development of the invention by installation mounts which are provided on frame sections of the supporting frame assigned to the installation feet. The supporting frame therefore provides installation mounts for the installation feet on frame sections below the cabin, as a result, the supporting frame is loaded with the cabin.

To further form the invention, it is also provided that each installation mount has a tray design. A tray design can be provided with peripheral edges, the installation feet can be set up therein. In addition, each installation mount is provided with at least one insulation, so that it is ensured that heat from the interior of the cabin also cannot be dissipated via the installation feet.

### BRIEF DESCRIPTION OF THE DRAWINGS

An exemplary embodiment of the invention, from which further features of the invention arise, is illustrated in the drawing. In the figures:

FIG. 1: shows a sectional view of a dryer for motor vehicle bodies according to the invention;

FIG. 2: shows a view of the detail II in FIG. 1 on an enlarged scale;

FIG. 3: shows a view of the detail III in FIG. 1 on an enlarged scale; and

FIG. 4: shows a view of the detail IV in FIG. 1 on an enlarged scale

### DETAILED DESCRIPTION OF THE PREFERRED EMBODIMENTS

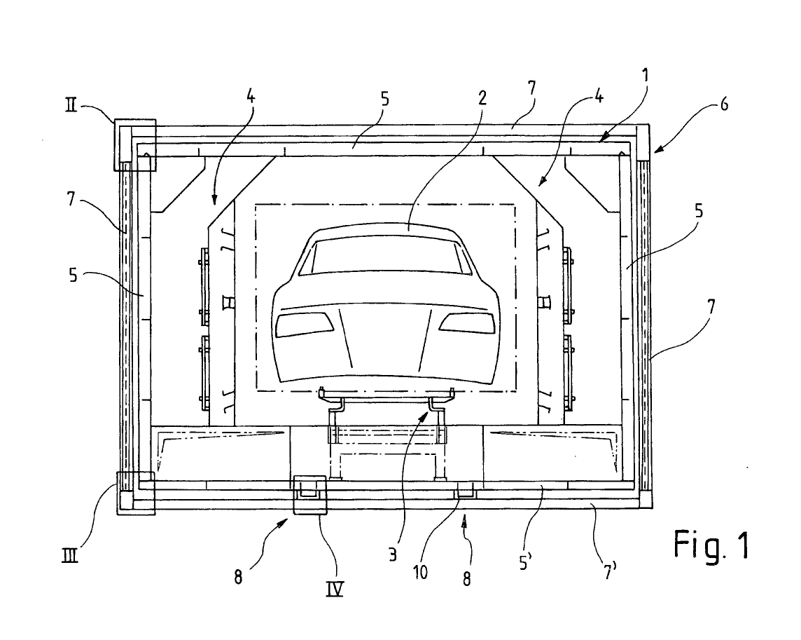

The dryer in FIG. 1 has a cabin 1 with a square cross section. The body 2 of a motor vehicle is guided through this cabin 1, corresponding guide devices 3 are used for this. Drying tools 4 are assigned to the guide path of the body 2 through the cabin 1.

The cabin 1 is constructed from walls 5, 5′. The walls 5, 5′ are self-supporting, they do not approach components arranged outside of the cabin 1.

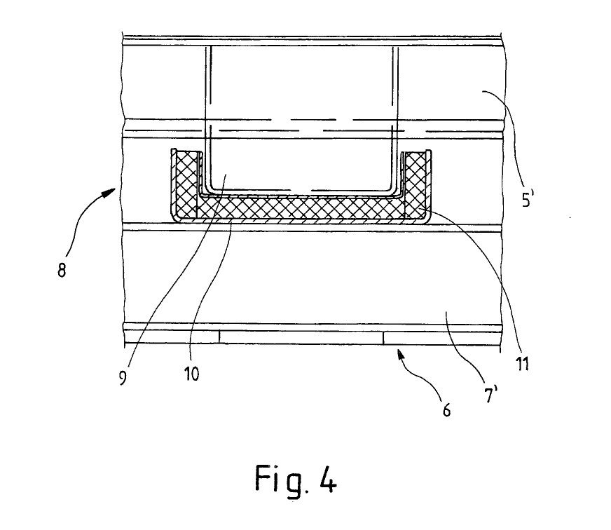

These components are formed by a supporting frame 6. The supporting frame 6 has frame sections 7, 7′. An air gap is formed in each case between a frame section 7, 7′ and the associated wall 5, 5′. This air gap is only interrupted in the region of installation feet 8 of the cabin 1, cf. FIG. 4.

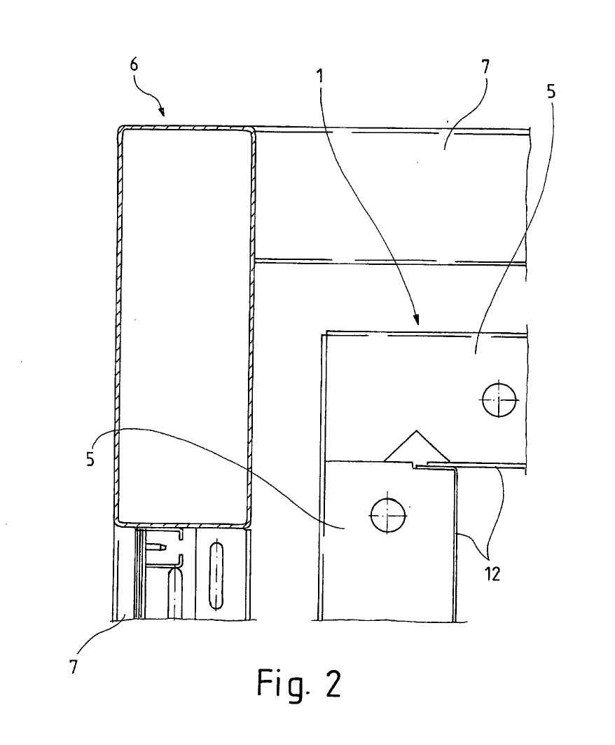

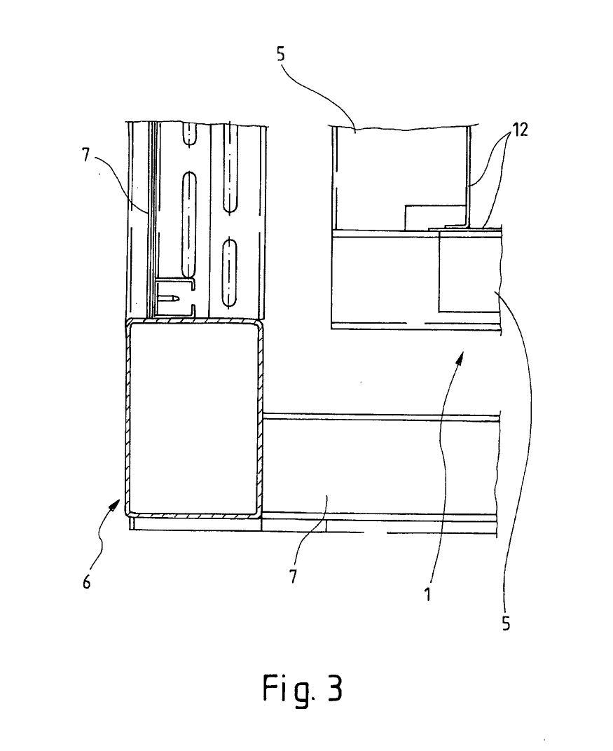

FIGS. 2 and 3 show corner constructions of the cabin 1 and of the supporting frame 6. Walls 5 and frame sections 7 do not abut, there is the air gap surrounding the cabin 1. In this case, both the walls 5 and the frame sections 7 are equipped with thermal insulation, the frame sections 7 can accordingly carry insulated facing boards with an outer skin. FIGS. 2 and 3 also show that sealing elements 12 are arranged on the abutting edges of mutually adjacent walls 5, 5′.

FIG. 4 shows the installation feet 8. The installation feet 8 are arranged on the wall 5′ of the cabin 1. The installation feet are installed on the frame section T of the supporting frame 6, installation mounts 10 are provided for this. The installation mounts 10 in each case have a tray design, they are in this case fastened on the frame section 7. Insulation 11 is introduced into the installation mounts 10.

All of the features mentioned in the preceding description and in the claims can be combined in any desired selection with the features of the independent claim. The disclosure of the invention is therefore not limited to the described or claimed feature combinations, rather all sensible feature combinations in the context of the invention are to be considered as disclosed.

1. A dryer for technical items, particularly for painted motor vehicle bodies, comprising at least one cabin for the technical items and for drying tools, wherein the cabin is constructed from walls which in each case have a spacing from components which are brought closer to the cabin from outside and differ from the installation feet of the cabin.

2. The dryer according to claim 1, wherein sealing elements are provided at the abutting edges of mutually adjacent walls of the cabin.

3. The dryer according to claim 2, wherein the sealing elements comprise folded metal sheets.

4. The dryer according to claim 1, wherein components brought from the outside closer to the cabin are combined to form a supporting frame, which has frame sections surrounding the cabin.

5. The dryer according to claim 4, wherein the supporting frame is framed with flat elements at least in certain sections.

6. The dryer according to claim 1, wherein installation feet are arranged on the outer side of the wall which is used as the floor of the cabin.

7. The dryer according to claim 6, wherein installation mounts are provided on frame sections of the supporting frame assigned to the installation feet.

8. The dryer according to claim 7, wherein each installation mount has a tray design.

9. The dryer according to claim 7, wherein each installation mount is equipped with at least one insulation.
